(19) United States
(12) Patent Application Publication
(10) Pub. No.: US 2010/0146008 A1
(43) Pub. Date: Jun. 10, 2010

(54) LIGHT-WEIGHT CONCURRENCY CONTROL IN PARALLELIZED VIEW MAINTENANCE

(75) Inventors: Hans-Arno JACOBSEN, Toronto (CA); Ramana Yerneni, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/331,842

(22) Filed: Dec. 10, 2008

(51) Int. Cl. G06F 17/30

(52) U.S. Cl. 707/802; 707/E17.009

(57) ABSTRACT

Aspects relate to maintaining, with a concurrent plurality of view managers, an aggregate view record that is derived from base data being updated. The aggregate view record is stored in a storage device. In a first example, a given base data update is propagated by one of the view managers reading a value from the aggregate view record and a sequence number, determining an updated value using the base data update, and submitting the updated value for writing, with the sequence number. The sequence number submitted with the writing is compared to a then-current sequence number stored in the storage device, and if there is a mismatch, then the view manager repeats the reading, determining, and submitting until there is no mismatch. A number of variations exist for different types of aggregates, which include counting, averaging, summing, and tracking minima and maxima. The concurrency mechanism is more easily scaled than a full ACID transaction model, which blocks both read transactions and write transactions until another transaction completes.

### BACKGROUND

1. Field

The following generally relates to database systems, and more particularly to propagating base table updates to views based on data derived from those base tables.

2. Related Art

Modern database systems comprise base tables that store directly updated data, and view tables that are derived from data obtained, directly or indirectly, from base tables (derived data). For example, a web store may use a base table for tracking inventory and another base table for tracking customer orders, and another for tracking customer biographical information. A person maintaining the web store may, for example, desire to analyze the data to prove or disprove certain hypotheses, such as whether a certain promotion was or would be successful, given previous order behavior, and other information known about customers.

The base tables are updated as changes are required to be reflected in the data. In other words, the base tables generally track or attempt to track facts, such as order placement, inventory, addresses, click history, and any number of other conceivable facts that may be desirable to store for future analysis or use. Thus, when base tables are updated, view tables that depend on data in those updated base tables ultimately should be updated to reflect those updates.

However, one concern is to avoid interfering with the main transaction systems involving applications making changes to the base tables, as the responsiveness of such systems generally affects a user's experience with the applications themselves. One conventional way to avoid slowing down systems interacting directly with users is to produce derived data (e.g., the view tables) “off-line”, so that the derived data reflects the status of the base data as of a certain update point. This approach has been acceptable because derived data was used mostly for analytics and business planning, and such uses did not require more up-to-date derived data.

Also, the amount of data generated in database systems continues to increase, as does the usage of derived data for a variety of purposes. Therefore, much greater demands are placed on systems maintaining derived data from base data updates. For example, current large scale database systems may need to handle hundreds of millions of view updates in a 24 hour period. Concurrent updating of derived data is increasingly necessary to keep up with these demands. However, concurrent updating of derived data cannot be undertaken without controls to avoid data corruption.

One approach that has been used to provide some measure of concurrency is provision of database systems that have strong Atomicity, Consistency, Isolation, and Durability (ACID) controls for each read and write transaction. Database storage systems providing such strong ACID transaction capabilities incur comparatively high overhead by implementing mechanisms to achieve these goals, and so make it difficult to scale such systems to the thousands of processing devices that would be used in such large scale database systems.

Thus, it would be desirable to provide, where possible, an approach that avoids causing view data inconsistencies, but does not incur the large overhead of using full ACID transactions. Preferably, such an approach also would be able to avoid extensive recovery procedures, such as rebuilding a view, to restore consistency.

### SUMMARY

The following disclosure relates to mechanisms providing controls for concurrent propagation of base table updates to aggregate views. A first aspect includes a database system method for concurrent view updating. The method can be executed in a plurality of view managers that are each operable to obtain base data updates and concurrently and independently propagate those updates to a view record. In the method, each view manager performs the update propagation by obtaining a respective base data update to be used in updating the view record, reading a value of the view record, as stored in a storage device, and obtaining a sequence number associated with the value when the value was read. Each view manager also performs an operation to produce a proposed update to the stored value, and submits the proposed update and the read sequence number to the storage device in a test and set transaction. Each view manager also determines whether a message received from the storage device, responsive to the submitting, indicates an update sequence error. If so, then each view manager returns to the reading step, and if no update sequence error is indicated, then each view manager treats its proposed update as committed and returns to the obtaining step for obtaining another respective base data update.

In formulating the received message, the storage device can be operable to compare the submitted sequence number with an update sequence number currently associated with the view record, and to form the message indicating the update sequence error if the submitted sequence number does not match the update sequence number currently associated with the view record.

Such methods also can include that each view manager is responsive to further errors indicated in the received message, including a record not found error. Responsive to such a message, each view manager can attempt to insert the view record, for which an update was attempted, with an initialized value. Such a situation may arise, for example, when maintaining a count view record. In some cases, the record may already have been inserted, such that the inserted can result in a record duplicate error, to which each view manager can respond by attempting to redo the method from the reading step. A variety of other variations can be provided for other types of aggregate views, which can include views for tracking one or more of sum, count, average, minimum, and maximum.

Another example aspect focuses on maintenance of views for extremas, such as a minimum or a maximum of an identified set of base data. In an example, a method comprises receiving a plurality of updates for a plurality of base records; and in each view manager of a plurality of view managers, performing operations comprising receiving one of the updates and attempting to read a current value of the view.

According to this example, if the attempt fails, the method includes attempting to insert the value from the received update, and if the attempt succeeds, then the method comprises receiving a sequence number associated with the received current value, and comparing the value from the received update with the read current value. The method also comprises, if the comparison indicates that the value from the received update sets a new extreme compared with the read current value, providing the value from the received update and the sequence number received by that view manager to the storage device. The method further comprises receiving a response to the providing; and if the response contains no error message, then the method comprises treating the update as committed. If the response includes an error message, then the method includes repeating the reading step.

In such a method, the received update can be for deleting the base record corresponding to the update, and the extreme value maintained can be equal to the received current value. The method can further comprise reading the values of the other base records to determine if another base record has a new extreme value, and if so then providing the new extreme value and the sequence number to the storage device.

Computer readable media and systems can be used in implementations as summarized above, and/or as described and claimed herein.

### BRIEF DESCRIPTION OF THE DRAWINGS

FIG. 1 illustrates a system in which aspects disclosed herein can be practiced;

FIGS. 2-3 respectively illustrate base tables that can be stored in the system of FIG. 1;

FIG. 4 illustrates view table derived from base data of the tables of FIGS. 2-3 and which can be maintained by and stored in the system of FIG. 1;

FIG. 5 illustrates incremental propagation of changes in base data to view data;

FIG. 6 shows how concurrently executing view update programs for propagating changes to base data can cause inconsistency in view data;

FIG. 7 illustrates steps of an exemplary method of concurrent updating of aggregate view records, and in particular, updating count records based on an inserted base record;

FIG. 8 illustrates steps of an exemplary method of concurrent updating of aggregate view records, and in particular, updating count records based on a deleted base record;

FIG. 9 illustrates steps of an exemplary method of concurrent updating of aggregate view records, and in particular, updating count records based on an updated base record, FIGS. 7-9 also apply to average and sum aggregates;

FIG. 10 illustrates an exemplary method for updating a view tracking extremes in base data, e.g., a minimum or a maximum, and in particular illustrates updating a minimum when a base record is added;

FIG. 11 illustrates an exemplary method for updating a view tracking extremes in base data, e.g., a minimum or a maximum, and in particular illustrates updating a minimum when a base record is deleted; and

FIG. 12 illustrates an exemplary method for updating a view tracking extremes in base data, e.g., a minimum or a maximum, and in particular illustrates updating a minimum when a base record is updated.

### DETAILED DESCRIPTION

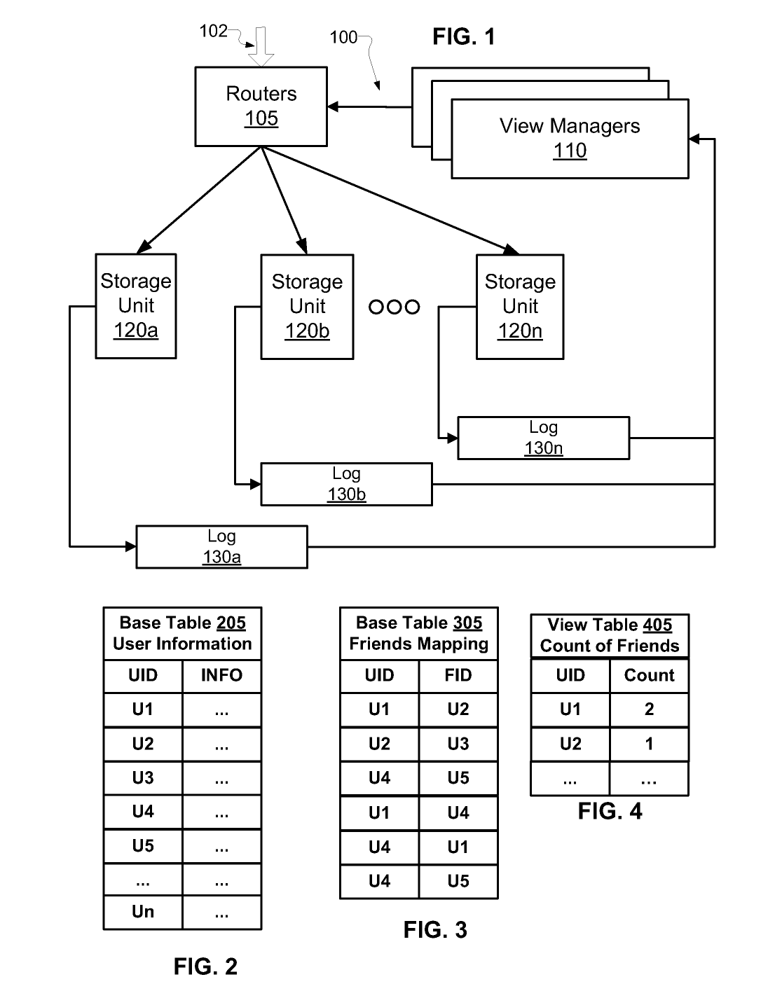

FIG. 1 illustrates a system 100 comprising a plurality of storage units 120a-120n into which routers 105 direct base record updates 102 and view record updates from view managers 110. Storage units 120a-120n output indicia of updates to base records to respective log segments 130a-130n. View managers 110 use log segments 130a-130n as inputs in producing the view record updates. Log segments 130a-130n can contain information indicating updates that were made to base records, including addition, deletion, and changes to data in existing records.

Log segments 130a-130n also can represent a path for providing results of queries made by view managers 110 of base records in storage units 120a-120n. For example, if a view manager conducts a read with a given key, then results can be considered to be provided through the logs. System 100 represents a generalization of any number of more particular implementations, which can include a variety of hardware and software resources for implementing storage of base records, view records, communications among storage components, computing resources for executing view manager operations and so on. View managers 110 can represent a plurality of threads of computing executing on one or more computing resources comprising, for example, many servers, potentially with multiple processors, each having multiple cores, thus representing a scenario where multiple view managers can be running concurrently, such that reads and writes conducted by those view managers may overlap in time.

FIG. 2 illustrates a base table 205 that can be stored in one or more of storage units 120a-120n, and can represent a table of user accounts, where UID represents respective unique user identifiers and INFO identifies one or more columns having fields where information descriptive of a given user can be stored, e.g., address, birthday, and so on. Since each UID is unique in base table 205, it can be used as a key for it.

FIG. 3 illustrates another base table 305 that can be stored in one or more of storage units 120a-120n, and can represent a mapping between each UID of table 205 and what other people have been identified as friends of that UID. For example, table 305 shows that U1 is friends with U2 and U4, while U2 is friends with U3. Table 305 is provided as a toy example for use in description herein, and so such implementation considerations as to whether table 305 would be symmetric are not addressed (e.g., it is not necessary to address whether a mapping between U2 in UID and U3 also implies that U3 is “friends” with U2).

FIG. 4 illustrates a view table 405 that represents a first view that tracks, per UID, a count of friends for that user. For example, based on table 305, U1 has two friends (U2 and U4), while U2 has one friend (U3). Such a view table can be formed from scratch by one of view managers 110 querying base data for each appearance of a given UID in table 305, querying a value of FID for each UID appearance, and writing a value to a corresponding count field in table 405. Now, in a situation where a web site has millions of users, it would be prohibitively difficult or impossible to construct view table 405 in this manner each time a user changed, added, or deleted their friends list. Thus, view table 405 can be incrementally updated, where a current value stored in a count field for a particular UID is read, and then incremented or decremented as necessary based on one or more changes to the base data (i.e., table 305). However, in an incremental change implementation, view managers 110 can read stale data, or overwrite another view manager's updates. This concern is pronounced in the context of views related to aggregates, such as SUM, MIN, MAX, and AVERAGE (AVG). Such aggregate views require one or more of a read of existing view information and a write to existing view information, so that concurrency between multiple view managers is a concern.

Example update patterns that can be of concern include where two view managers 110 read or write a view record based on different base data updates. Such situations occur, for example, when an aggregate view, such as SUM, COUNT, and AVG, MIN and MAX views (i.e., a view that derive such information from base records) is maintained incrementally. In a more particular example, a view record can be maintained by a plurality of view managers incrementally, such that when a base record update to a given set of base records (e.g., adding a record to the set, deleting a record from the set, or updating a record in the set), a view manager propagates that base record update to the view. Scaling that situation up dramatically, many view managers ideally would be able to concurrently propagate base record updates to a view, while maintaining consistency of the view.

Examples for providing such consistency while increasing concurrency are described below.

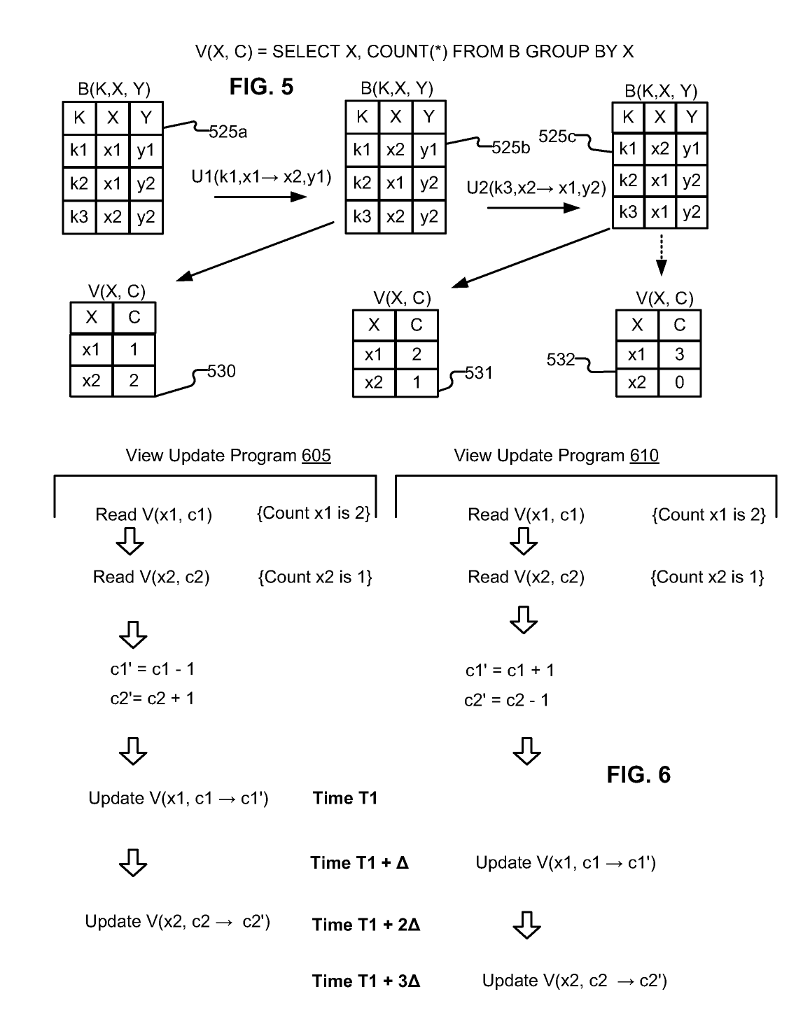

FIG. 5 illustrates an example where a base table 525a includes keys k1, k2, and k3. Each key is associated with a value from each of an x column and a y column. As such, base table 525a represents a generalization of base table 305, with a separate key identifier for each entry of the database. A first update to the base table, U1, causes the x column value associated with key k1 to be changed from x1 to x2, resulting in the base table identified as 525b. Now, if a view table is maintained incrementally tracking counts of how many times x1 and x2 each appear in entries for different keys, then an update would be triggered that would cause a view table 530 to be updated to show that x1 now appeared only once in base table 525b, while x2 appeared twice. Then, assume that another base update, U2, represents changes that need to be inputted into the database, which include that the x column of key k3 is changed from x2 to x1. This change would result in base table 525c. It also would trigger a view update that should cause table 531, which represents that x1 is associated with two entries from base table 525c, while x2 is associated with one entry. However, under some conditions, an incorrect result can occur, wherein a view table 532 results that does not accurately represent the contents of underlying base data, which shows that x1 is associated with 3 entries and x2 is associated with 0 entries.

A situation where an incorrect result can occur in a non-ACID situation is described with respect to FIG. 6. FIG. 6 illustrates side-by-side flow of a view update program 605 and a view update program 610. View update program 605 is for implementing the view update responsive to the U1 base table update while view update program 610 is for implementing the view update responsive to the U2 base table update.

Each of view update program 605 and 610 would read the current value from the view table for each of the count of x1 (C1) and of x2 (C2) at a time when count of x2 is 2 and count of x1 is 1. Subsequently, each program 605 and 610 computes an update for each count. Program 605 writes its updated count x1 value back at T1, program 610 writes its count of x1 value back at T1 plus Δ, program 605 writes its updated count x2 value back at T1 plus 2Δ. Program 610 writes its count of x2 value back at T1 plus 3Δ. Thus, program 610 overwrites program 605 updates for both count of x1 and count of x2. In such a situation, the program 605 updates cannot easily be recovered, or reconstructed, and the view table ultimately ends in an incorrect state.

The following discloses various examples of how to implement aggregate updates concurrently and consistently on platforms that do not provide ACID transaction capability, but do provide Test and Set (TAS) functionality. TAS functionality can proceed as follows, using the example of FIG. 5 and FIG. 6. In TAS, when a view program desires to update a value, the view program reads the value and updates a sequence number corresponding to the value read. For example, when view program 605 desired to update value count of x1, program 605 would also have received a sequence number for count of x1 at that time. Similarly, program 605 also would have obtained a sequence number for the current value in count of x2. Then, during writeback, program 605 would provide the sequence numbers it received during reading back to the storage facility, which then would use the provided sequence numbers to determine whether there had been an inconsistency. The inconsistency would be detectable because the sequence number in the storage facility would have been incremented during the write by program 610, and so the sequence numbers provided by program 605 would be detected as being stale. For example, if the sequence number was incremented by 1 for each update, then stale sequence numbers can be detected as being lower in value than a current sequence number. Thus, where a TAS update is called for, the TAS update includes providing with a value for storing (i.e., an updated data element) a signature, serial number, sequence number or equivalent data element that allows a determination whether an intervening write has occurred which rendered data used to produce the data element to be written, and which here is generally called a sequence number to convey a convenient approach were an incrementing sequence allows stale data detection. This terminology however is not by way of loss of generality, but for convenience of description. For example, although preferable to have an incrementing sequence number, other implementations to disambiguate updates may be provided, and sequence number is not intended to be limited to an incrementing sequence.

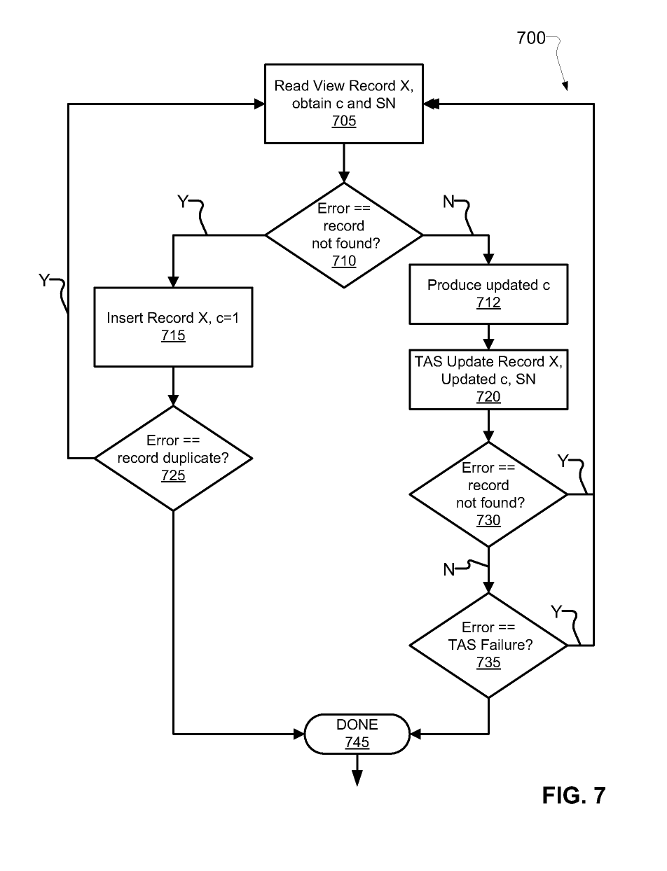

A first example is a flow for implementing insertion updates, as illustrated in FIG. 7 with example method 700 relating to maintaining a count (e.g., a number of items in a set) and with pseudocode from Table 1, below. Method 700 comprises reading 705 a view record, at a storage device, to obtain a current count (c) from the view record, and a Sequence Number (SN). The storage device can return an error message for the read, as well as for other operations as described below.

Method 700 includes determining (710) whether a record not found error message was returned. Such a message can be an indicator that a concurrently operating view manager deleted the record, because it decremented the count to zero, for example. If there was a record not found error message, then method 700 includes attempting to insert the record, with a count of 1; the sequence number can be initialized to 0, 1, or any arbitrary value. Method 700 also includes determining 725 whether a record duplicate error was returned in response to record insertion 715. If so, then this error message can indicate that another concurrent view manager already inserted the record, and if so, then method 700 returns to 705 to read the count, and the sequence number again. In the figures, an explicit showing of an return error code being assigned to the variable “Error”, which is later checked for certain error codes is omitted, but it would be understood that the variable error is assigned such codes, based on the operations undertaken in the specific example, and as shown in the pseudocode.

If there was no error detected at 725, then method 700 can complete 745, treating the update, which ultimately was effected by an insertion of a record as compared with incrementing a value in an existing record, as committed.

Returning to 710, if there was no record not found error, then the view record was read successfully, and an updated count value can be produced 712, and used in a TAS update to the view record 720, providing the updated count value and the sequence number read at 705. At 730, method 700 again checks whether there is a record not found error message (concurrent view manager could have deleted it), and if so, then method 700 returns to 705, because the count value attempted to be written would not be accurate. If the record was found, method 700 then checks for a TAS error 735, which if returned indicates that a concurrent view manager made changes, evidenced by mismatching sequence numbers between a sequence number stored by the storage device and one provided with the TAS update. If so, then method 700 returns to 705 to read again the then-current count and SN. Otherwise, method 700 can complete 745, treating the update as committed.

The pseudocode of Table 1 illustrates an example of how to propagate an inserted base record to an aggregate view, such as to count a number of base records having a certain quality. For example, FIG. 2 illustrated a base table 205 with User Identifiers (UIDs). A view table could be maintained to count a number of user identifiers, such that when one was added by a new user application to the base data, there would be a base data update causing incrementing of the count maintained in the view. In all the tables that follow, the “error=<operation>” language indicates that “error” is populated by a storage device (e.g., storage units 120a-120n) with an error message, some of which were described above, and also appear in the pseudocode (e.g., RECORD_NOT_FOUND, RECORD_DUPLICATE, and so on). The formatting and wording for such error messages can vary, and their description herein can be varied as well. In the pseudocode of the following tables, and in the counterpart flow charts, information concerning further error handling functionality is omitted for clarity. For example, conventional error handling techniques can be implemented to avoid infinite loops; such techniques can include maintaining status information such as a number of retries attempted, and so on.

TABLE 1
COUNT Insert Propagation

```
propagate_insert(R(k, x, y)): {
  INSERT_START: error = read(V(x, ?c), ?sn);
  if (error == RECORD_NOT_FOUND) {
      error = insert(V(x, 1), 1);
      if (error == RECORD_DUPLICATE) {
        GOTO INSERT_START;
      }
  } else {
      error = update_tas(V(x, c→c + 1), sn);
      if ((error == RECORD_NOT_FOUND) or
        (error == TAS_FAILURE)) {
        GOTO INSERT_START;
      }
    }
}
```

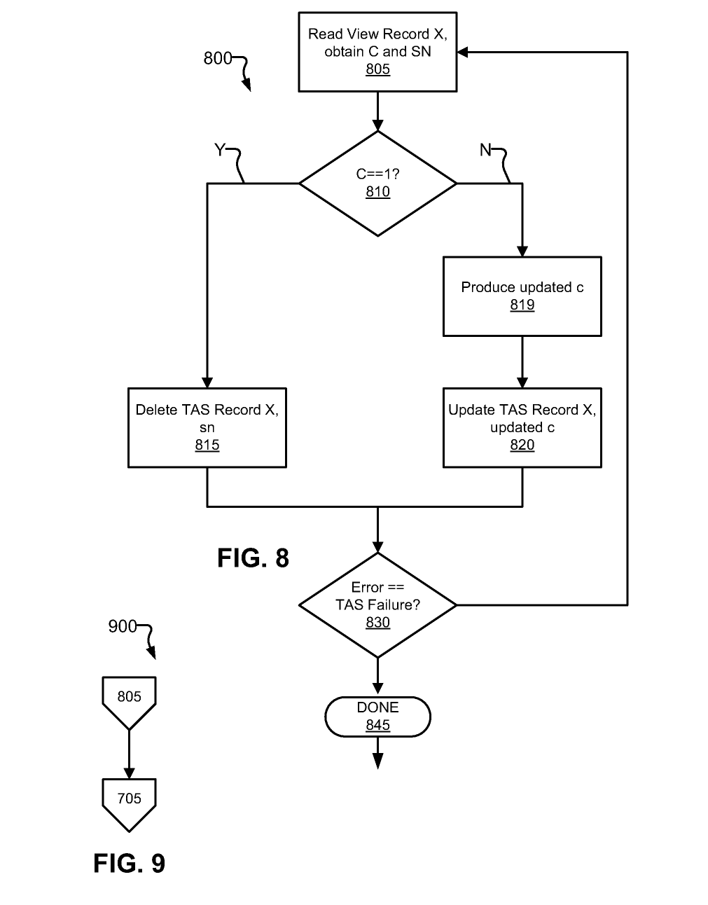

FIG. 8 illustrates a method 800 that can be used in propagating decrement/delete base updates. In the context of method 700, which could be used for adding/incrementing, method 800 provides the counterpart method allowing, for example, deleting of base records, and causing aggregations of data in those base records to be updated accordingly. Like method 700, method 800 is example drawn to counting, while later examples concern other aggregate views.

Method 800 includes reading a view record to obtain a count, and a sequence number associated with the count by a storage device (i.e., the sequence number associated with the currently stored count). Method 800 includes checking whether the count read is equal to 1 (810), which is an example minimum value for the example of decrementing by 1 (other minimum values can be used for different applications.) Note that in this example, method 800 does not need to check whether the record exists, as was done in method 700, because the particular base update being handled is an indicator that there still must be at least some count remaining to be decremented, so the view record would still exist.

If count is 1, then method 800 submits a delete TAS 815 for that record, supplying the sequence number obtained during reading, and in response 830 to a TAS failure (e.g., caused by mismatching sequence numbers), method 800 returns to reading 805 the view record again. If the count was not 1, then method 800 produces 819 an updated count (e.g., decrementing by 1), and submits 820 a TAS update with the updated count, and the sequence number. Method 800 also include checking for a TAS failure in response to the update TAS (e.g., mismatching sequence numbers), and for such an error, method 800 returns to reading 805. If no failure was detected at 830 for either 815 or 820, then the update can be treated as having been committed and method 800 is done 845.

As can be discerned for both method 700 and method 800, a number of iterations may be performed to propagate a given base table update to a given view record, if many view managers are concurrently processing different base table updates to that view record. This can be because, for example, another view manager will write an updated value while another view manager, even though having read prior, submits its update later. Although this looping causes some inefficiency, it is more scalable than traditional ACID mechanisms that are difficult to scale beyond systems with a hundred or so nodes. The present methods are expected to enable scaling to thousands and tens of thousands of nodes. The pseudocode of Table 2 relates to method 800.

TABLE 2
COUNT Delete Propagation

```
propagate_delete(R(k, x, y)): {
  DELETE_START: read(V(x, ?c), ?sn);
  if (c == 1) {
    error = delete_tas(V(x, c), sn);
    if (error == TAS_FAILURE)) {
      GOTO DELETE_START;
    }
  } else {
    error = update_tas(V(x, c→c − 1), sn);
    if (error == TAS_FAILURE)) {
      GOTO DELETE_START;
    }
  }
}
```

FIG. 9 illustrates a method 900, illustrated as a concatenation of method 800 and method 700 (represented by entering method 800 at 805, and exiting method 800 to enter method 700 at 705.) Method 900 allows for updating of counting-type view record aggregations. Table 3, below, illustrates pseudocode for such updating.

TABLE 3
COUNT Update Propagation

```
propagate_udpate(R(k, x →x’, y →y’)): {
  DELETE_START: read(V(x, ?c), ?snx);
  if (c == 1) {
    error = delete_tas(V(x, c), snx);
  } else {
    error = update_tas(V(x, c→c − 1), snx);
  }
  if (error == TAS_FAILURE)) {
      GOTO DELETE_START;
  }
  INSERT_START: error = read(V(x’, ?c’), ?snx’);
  if (error == RECORD_NOT_FOUND) {
        error = insert(V(x’, 1), 1);
        if (error == RECORD_DUPLICATE) {
          GOTO INSERT_START;
        }
  } else {
        error = update_tas(V(x’, c’→c’ + 1), snx’);
        if ((error == RECORD_NOT_FOUND) or
(error == TAS_FAILURE)) {
            GOTO INSERT_START;
        }
    }
}
```

The above description relates that view managers can implement operations according to three basic types, to account for different types of updates that may occur to a set of base records from which an aggregate view is derived. Variations on these operations are presented below for different types or categories of aggregate views.

Table 4, below, includes pseudocode for an example where view managers can be concurrently maintaining a sum for a group of base records, such that when a new base record is added to the group, one of the view managers would add a value from that new base record to the sum. Since the methodology is similar to that of count insert view updating, this pseudocode is described more briefly (also, pseudocode for Table 4 is also used in describing how an average may be maintained for a group of base records, as described below).

Table 4 shows that sum insert propagation includes reading a current sum, and a sequence number, checking whether the record was found or not, and if not found, then inserting the record, with a sequence number. The code is responsive to an error indicating that the insertion would cause a duplicate by returning to read the sum again. If the sum was there, then it is TAS updated with a value from the base record update being propagated. If the TAS update returns an error of either record not found or failure due to sequence number mismatch, the code rereads the sum, and if not then the update was successful.

A view maintaining an average can also be provided. One way to provide an average is to store a sum and a count for the data desired to be averaged, and calculate the average by dividing the sum with the count. In maintaining such an average, when a sum is updated for a new value, a count also would be updated, while if an existing value were revised, then the count would not be updated. The updates would be accomplished using the TAS update approach described above. Of course, if it desired to avoid explicitly calculating the average when the average is needed, the average also could be stored explicitly in a view record. In a still further alternative, an average and a count could be stored, and a sum could be calculated, when needed, based on the average and count. Thus, a view maintaining an average can be considered a usage both of updating a sum and a count value, according to the methodologies described below.

TABLE 4
SUM Insert Propagation

```
propagate_insert(R(k, x, y)): {
  INSERT_START: error = read(V(x, ?sum, ?count), ?sn);
  if (error == RECORD_NOT_FOUND) {
      error = insert(V(x, y, 1), 1);
      if (error == RECORD_DUPLICATE) {
        GOTO INSERT_START;
      }
  } else {
      error = update_tas(V(x, sum → sum + y, count → count + 1), sn);
      if ((error == RECORD_NOT_FOUND) or
        (error == TAS_FAILURE)) {
        GOTO INSERT_START;
      }
    }
}
```

Sum delete propagation is analogous to count delete propagation, and pseudocode for sum delete propagation shown in Table 5 below can be understood by reference to the count delete discussion above. Analogous to the discussion of maintaining averages with respect to sum insert above, a count also can be maintained in sum delete pseudcode.

TABLE 5
SUM Delete Propagation

```
propagate_delete(R(k, x, y)): {
  DELETE_START: read(V(x, ?sum, ?count), ?sn);
  if (c == 1) {
    error = delete_tas(V(x, sum, count), sn);
    if (error == TAS_FAILURE)) {
      GOTO DELETE_START;
    }
  } else {
    error = update_tas(V(x, sum → sum − y, count → count − 1), sn);
    if (error == TAS_FAILURE)) {
      GOTO DELETE_START;
    }
  }
}
```

Sum update propagation is analogous to count update propagation, and pseudocode for sum update propagation shown in Table 6 below can be understood by reference to the count update discussion above. Analogous to the discussion of maintaining averages with respect to sum insert above, a count also can be maintained in sum update pseudcode. Sum update, like count update, can be used when both changing a value from one group to another. For example, if respective sums of salaries were maintained for two groups, and a person switched from one group to another (i.e., base data would reflect that the person switched from one group of base data to another), that base record update could be propagated to view records for each sum using operations according to the example of Table 6 pseudocode.

TABLE 6
SUM Update Propagation

```
propagate_update(R(k, x→x’, y→y’)): {
  DELETE_START: read(V(x, ?s, ?c), ?snx);
  if (c == 1) {
    error = delete_tas(V(x, s, c), snx);
  } else {
    error = update_tas(V(x, s → s − y, c→c − 1), snx);
  }
  if (error == TAS_FAILURE)) {
    GOTO DELETE_START;
  }
  INSERT_START: error = read(V(x’, ?s’, ?c’), ?snx’);
  if (error == RECORD_NOT_FOUND) {
    error = insert(V(x’, y’, 1), 1);
    if (error == RECORD_DUPLICATE) {
      GOTO INSERT_START;
    }
  } else {
    error = update_tas(V(x’, s’→ s’ + y’, c’ → c’ + 1), snx’);
    if ((error == RECORD_NOT_FOUND) or
(error == TAS_FAILURE)) {
      GOTO INSERT_START;
    }
  }
}
```

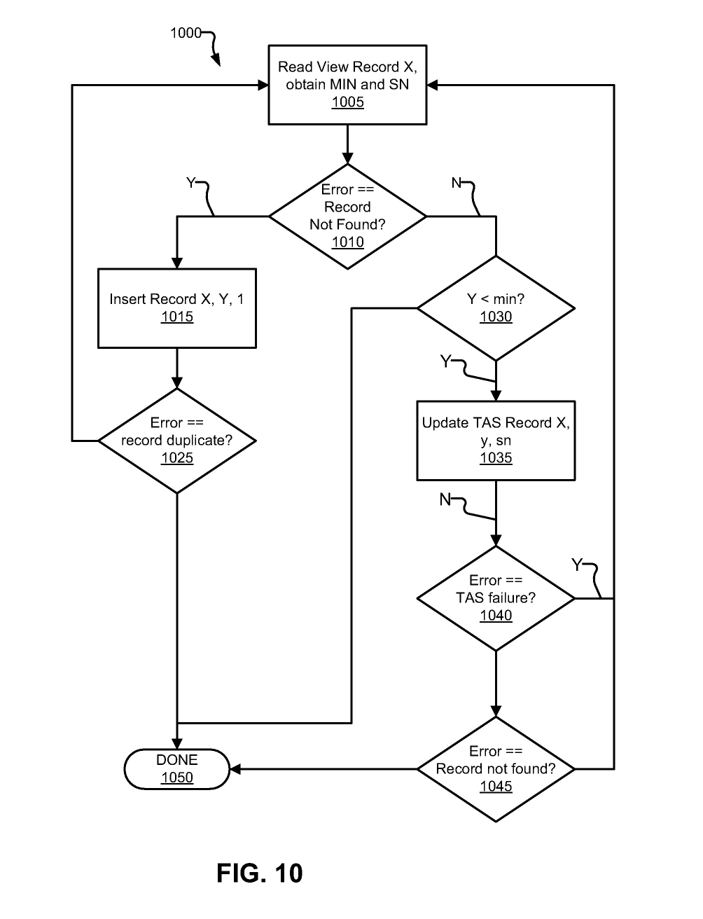

FIG. 10 illustrates a method 1000 that can be executed by view managers maintaining a view record relating to maintaining a minimum for a group of entries. The maintenance method 1000 can be initiated in response to receiving a base data update, which can include for example insertion of a new base record that has a value which may be a minimum for which the view record would require updating. Method 1000 can begin with attempting to read 1005 a view record to obtain a current minimum (i.e., a previously identified minimum of a set of base records) and a sequence number. If the read attempt caused return (1010) of a record not found error message, then method 1000 includes attempting insertion 1015 of an appropriate record, where the minimum would be the value provided with the base update (i.e., the present, and apparently only value would be the minimum). The sequence number can be reset to 1 or another known number. If the record insertion causes return of a record duplicate error message (1025), then method 1000 returns to reading 1005 the view record again. If there was no error message at 1025, then the insertion was successful (1050) and the base update was successfully propagated to the view record.

If a record not found error was not returned (1010), then the value returned in the read (MIN) is compared 1030 with the value of the base data triggering the update (here, identified as Y). If Y is less than MIN, then method 1000 includes test and set updating 1035 the view record with Y as the new MIN, which includes providing the sequence number read at 1005 to a storage device from which the MIN was read. If a TAS failure is returned (1040), then method 1000 returns to reading 1005, which as described above, indicates that another value was added, and for which the comparison at 1030 must be performed again, before updating MIN. In the absence of a TAS failure error, a record not found error also could be returned in the message responsive to the update attempt, and this condition is checked (1045). In the presence of a record not found error, method 1000 returns to reading (1005) the view record. Without either error condition (1040 or 1045), the update can be considered completed (1050).

Method 1000 was for a particular example of tracking a minimum. However, a converse maximum tracking method may be implemented by determining whether a stored maximum was less than a value indicated for a base record update, and if so then updating the maximum with that value. Table 7 illustrates MIN insert pseudocode.

TABLE 7
MIN Insert Propagation

```
propagate_insert(R(k, x, y)): {
  INSERT_START: error = read(V(x, ?m), ?sn);
  if (error == RECORD_NOT_FOUND) {
        error = insert(V(x, y), 1);
        if (error == RECORD_DUPLICATE) {
          GOTO INSERT_START;
        }
  } else {
    if (y < m) {
        error = update_tas(V(x, y), sn);
        if ((error == RECORD_NOT_FOUND) or
          (error == TAS_FAILURE)) {
          GOTO INSERT_START;
        }
    }
    }
}
```

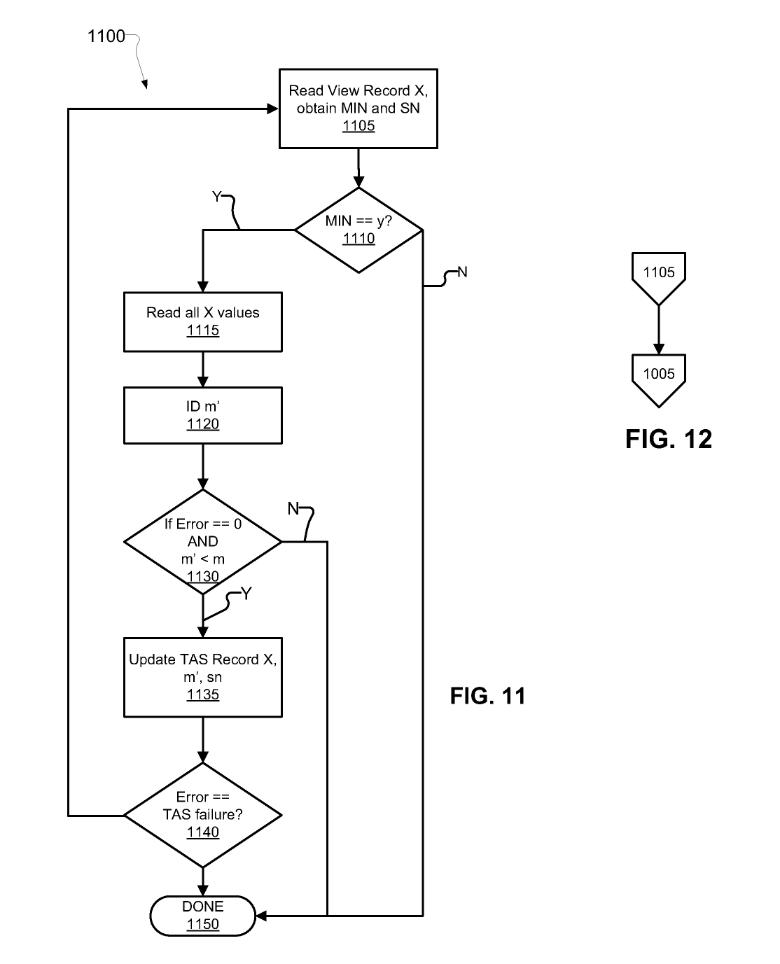

FIG. 11 illustrates a method 1100 that can be for updating a MIN (and conversely a maximum with appropriate changes) for base record deletions. Method 1100 includes reading (1105) a current minimum and a sequence number from a storage device. Here, the operation is for base record deletion, and so a check does not need to be made as to the existence of the view record, since the deletion of at least one base record would indicate that a view record tracking a minimum would continue to exist. Method 1100 includes determining 1110 whether the MIN read in 1105 matches the value of the base record update. If the value does not match, then the record is not a record that is relevant to maintaining the current minimum, the view record needs no updating, and method 1100 can complete 1150. If the value does match, then all values for the set for which the MIN is maintained are read 1115, and a minimum of these values is determined 1120. If there was no error during the reading (1130) and the minimum from 1120 is less than the value Y (or equivalent to the previous minimum), then a TAS update (1135) is performed with the new minimum and the sequence number. A TAS failure (1140) causes method 1100 to return to 1105. Table 8 below illustrates pseudocode for an example MIN delete operation according to FIG. 11.

TABLE 8
MIN Delete Propagation

```
propagate_delete(R(k, x, y)): {
  DELETE_START: read(V(x, ?m), ?sn);
  if (m == y) {
    error = read(R(-, x, min(y) → m’));
    if ((error == 0) and (m’ < m)) {
      error = update_tas(V(x, m’), sn);
      if (error == TAS_FAILURE)) {
        GOTO DELETE_START;
      }
    }
  }
}
```

FIG. 12 illustrates MIN/MAX update propagation may be viewed as a concatenation of a MIN delete operation and a MIN Insert operation, as shown by entering step 1105 of FIG. 11, performing the steps of method 1100, and then exiting method 1100 to enter step 1005 of FIG. 10. Table 9 below also illustrates pseudocode for MIN update.

TABLE 9
MIN Update Propagation

```
propagate_update(R(k, x→x’, y→y’)): {
  DELETE_START: read(V(x, ?m), ?sn);
  if (m == y) {
    error = read(R(-, x, min(y) → m”));
    if ((error == 0) and (m” < m)) {
      error = update_tas(V(x, m”), sn);
      if (error == TAS_FAILURE)) {
        GOTO DELETE_START;
      }
    }
  }
INSERT_START: error = read(V(x’, ?m’), ?sn’);
  if (error == RECORD_NOT_FOUND) {
        error = insert(V(x’, y’), 1);
        if (error == RECORD_DUPLICATE) {
          GOTO INSERT_START;
        }
  } else {
    if (y’ < m’) {
        error = update_tas(V(x’, y’), sn’);
        if ((error == RECORD_NOT_FOUND) or
          (error == TAS_FAILURE)) {
          GOTO INSERT_START;
      }
    }
  }
}
```

Table 10 below illustrates pseudocode for a MAX insert update (e.g., an update to a view record caused by insertion of a base record). As evident, MAX insert parallels MIN insert, with appropriate changes for value comparisons.

TABLE 10
MAX Insert Propagation

```
propagate_insert(R(k, x, y)): {
  INSERT_START: error = read(V(x, ?m), ?sn);
  if (error == RECORD_NOT_FOUND) {
        error = insert(V(x, y), 1);
        if (error == RECORD_DUPLICATE) {
          GOTO INSERT_START;
        }
  } else {
      if (y > m) {
        error = update_tas(V(x, y), sn);
        if ((error == RECORD_NOT_FOUND) or
          (error == TAS_FAILURE)) {
          GOTO INSERT_START;
        }
    }
    }
}
```

Table 11 below illustrates pseudocode for a MAX delete update (e.g., an update to a view record caused by deletion of a base record). As evident, MAX delete parallels MIN delete, with appropriate changes for value comparisons.

TABLE 11
MAX Delete Propagation

```
propagate_delete(R(k, x, y)): {
  DELETE_START: read(V(x, ?m), ?sn);
  if (m == y) {
    error = read(R(-, x, max(y) → m’));
    if ((error == 0) and (m’ > m)) {
      error = update_tas(V(x, m’), sn);
      if (error == TAS_FAILURE)) {
        GOTO DELETE_START;
      }
    }
  }
}
```

Table 12 below illustrates pseudocode for a MAX update update (e.g., an update to a view record caused by updating of a base record). As evident, MAX update parallels MIN update, with appropriate changes for value comparisons.

TABLE 12
MAX Update Propagation

```
propagate_update(R(k, x→x’, y→y’)): {
  DELETE_START: read(V(x, ?m), ?sn);
  if (m == y) {
    error = read(R(-, x, max(y) → m”));
    if ((error == 0) and (m” > m)) {
      error = update_tas(V(x, m”), sn);
      if (error == TAS_FAILURE)) {
        GOTO DELETE_START;
      }
    }
  }
INSERT_START: error = read(V(x’, ?m’), ?sn’);
  if (error == RECORD_NOT_FOUND) {
        error = insert(V(x’, y’), 1);
        if (error == RECORD_DUPLICATE) {
          GOTO INSERT_START;
        }
  } else {
    if (y’ > m’) {
        error = update_tas(V(x’, y’), sn’);
        if ((error == RECORD_NOT_FOUND) or
          (error == TAS_FAILURE)) {
          GOTO INSERT_START;
      }
    }
  }
}
```

In the above examples and other described aspects, methods and pseudocode were presented that would be implemented in a plurality of concurrently executing view managers. Each view manager can operate essentially independently, in that it can be responsible for propagating a given base record update to one or more appropriate view records, without explicitly coordinating, or being coordinated with the other view managers. By contrast, a full ACID transaction model operates using explicit coordination among entities seeking to update a given record. This system of explicit coordination is acceptable for some systems, but it does highly scale, since the explicit coordination overhead becomes too great as a number of participants in the system gets too large. In some examples, systems and methods according to aspects described are for use in systems having many thousands of view managers that can be updating many view records, where a plurality of view managers may be assigned to maintain larger view records.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Examples of how the disclosed methods and associated computer code transform a particular article into a different state or thing include that the particular article can include memories containing values tracking views (e.g., aggregate views, such as counts, averages and the like) that relate to base data, which can represent physical events (such as purchases, sales, inventory changes, objects, people's activities, such as logins, e-mails, and so on). The view(s) stored in the memories are updated as the base data changes, which transforms the memory into a different state. Also, a memory storing any given value is a legally distinct thing from a memory storing a different value; thus, the updating also makes the memory a legally distinct thing. Of course, it would be apparent from these disclosures that these merely are examples of such transformations. Further, embodiments disclosed herein can be implemented machines, including specific machines for maintaining such information, which can be called databases.

Those of skill in the art will appreciate that embodiments may be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

We claim:

1. A database system method for concurrent view updating, comprising:
in each view manager of a plurality of view managers, each operable to maintain an aggregate view record, concurrently and independently performing steps comprising:
obtaining a respective base data update to be used in updating the view record;
reading a value of the view record, as stored in a storage device, and obtaining a sequence number associated with the value when the value was read;
performing an operation to produce a proposed update to the stored value;
submitting the proposed update and the read sequence number to the storage device in a test and set transaction; and
determining whether a message received from the storage device, responsive to the submitting, indicates an update sequence error, and if so then returning to the reading step, and if no update sequence error is indicated, then treating the proposed update as committed and returning to the obtaining step for obtaining another respective base data update.

2. The method of claim 1, wherein the storage device is operable to compare the submitted sequence number with an update sequence number currently associated with the view record, and to form the message indicating the update sequence error if the submitted sequence number does not match the update sequence number currently associated with the view record.

3. The method of claim 1, wherein the update sequence error includes a record not found error, and further comprising responding to the record not found error by attempting to insert the view record with an initialized value.

4. The method of claim 3, wherein the initialized value is one, if the view record is for maintaining a count.

5. The method of claim 3, wherein the update sequence error includes a record duplicate error, responsive to the attempting to insert the view record, and responsive to the record duplicate error, returning to the reading step.

6. The method of claim 3, wherein the initialized value is based on a value calculated from the base data update, if the view record is for maintaining a sum or an average.

7. The method of claim 1, wherein the view managers are operable to maintain the view record in response to updates made to base table records, from which the view record derives information.

8. The method of claim 1, wherein the view record tracks one of a sum, a count, an average, a minimum, and a maximum for a set of base data.

9. The method of claim 8, wherein each of the view managers receives respective indicators of updates to different base data records, and maintains the view record based on the respective base data records updates.

10. A scalable system for concurrent maintenance of aggregate derived data with updates to base data, comprising:
a storage resource operable for maintaining a value of a view record, and incrementing an update sequence number for each committed update to the value;
a source of base record updates for which the view record may require updating; and
a plurality of view managers, each configured to maintain, responsive to base record updates, the view record by independently performing operations comprising
(1) reading, from the storage resource, the view record value and the update sequence number,
(2) determining an update for the view record,
(3) submitting the update and the read update sequence number to the storage resource,
(4) receiving a message responsive to the submitting, and
responsive to an update sequence error indication in the message, repeating (1)-(4), and absent an error indication, treating the update as committed to the storage resource.

11. The system of claim 10, wherein the view managers are each responsive to a record not found error indication in the message by repeating (1)-(4).

12. The system of claim 10, wherein the view managers are further operable to effect the update by inserting the view record, in response to receiving a view record not found error message, responsive to the step of reading.

13. The system of claim 12, wherein the view managers are further operable to receive a view record duplicate error message responsive to the insertion, and responsive to the view record duplicate error, repeating (1)-(4).

14. The system of claim 10, wherein the update represents an increment of the value read from the view record.

15. The system of claim 10, wherein the update represents a decrement of the value read from the view record.

16. The system of claim 10, wherein, for a base table update requiring decrementing the value of the view table, the view managers are further operable to determine whether the view table value can be further decremented, and if not, then determining that the update is a delete operation, and to be responsive to a record not found error indication in the message by continuing with the reading.

17. A database system implementing concurrent updating of aggregate view records derived from base data, comprising:
a storage device operable to
store a current value of an aggregate view record,
incrementally maintain a sequence number for updates committed to the current value of the view record,
return, responsive to a read, the current value and the sequence number,
accept write requests comprising a verifying sequence number and a new value, and
generate a response message indicating one of storage of the new value or an error, the error potentially indicative of mismatch between the verifying sequence number and a then-current sequence number stored in the storage device; and
a plurality of view managers, each view manager operable to maintain the aggregate view record responsive to updates to a set of base data by
(1) reading the current value and sequence number,
(2) producing a proposed update to the current value, and
(3) producing a write request for the updated current value,
responsive to the response message, performing (1)-(3) again if the response message contains an error, and if the response message contains no error, then treating the update as committed.

18. The database system of claim 17, wherein the aggregate view record is for maintaining a sum, an average, a count, a minimum or a maximum.

19. A computer readable medium storing computer readable instructions for a method of concurrent base record update propagation to view records, comprising:
receiving a plurality of base record updates; and
in each view manager of a plurality of view managers,
reading a current value of a view record, and receiving a sequence number associated with the then-current value, the read serviced by a storage device without checking for blocking transactions then outstanding,
using one or more of the base record updates to compute an update to the respective current value read by that view manager,
providing the computed current value update and the sequence number received by that view manager to the storage device,
receiving a response to the providing, and
if the response contains no error message, then treating the one or more base record updates used to compute the current value update as committed, and if the response includes an error message, then repeating the reading.

20. The computer readable medium of claim 19, wherein the view record is for counting a characteristic of the base records, and further comprising determining whether a record not found error message was provided in response to the reading, and if so then attempting to insert a new record with an initial value, if the view manager was attempting to increment the current value.

21. The computer readable medium of claim 19, further comprising determining whether the current value would be zero after changes for a computed value update, and if so then attempting to delete the view record, also providing the received sequence number, and if there is an error in response to the deleting, then continuing with the reading.

22. The computer readable medium of claim 19, wherein the view record maintains a sum of values from the base records, and the computed current value update includes an updated sum.

23. The computer readable medium of claim 22, wherein the view record also maintains a count of values used in the sum from the base records, and each view manager reads the count with the current sum of values, the count being updated and provided to the storage device with the sequence number and the updated sum.

24. The computer readable medium of claim 23, wherein decrementing the sum of values occurs responsive to a base record update indicating deletion of its base record, unless the count shows that only one base record forms the sum, then attempting to delete the view record, and responsive to an error message caused by the deletion attempt, continuing with the original step of reading.

25. The computer readable medium of claim 22, wherein the sum can be both incremented and decremented based on values respectively being added to and deleted from the base records.

26. The computer readable medium of claim 25, wherein the adding of values to the base records comprises adding new base records, and the deleting of values from the base records comprises deleting existing base records.

27. The computer readable medium of claim 19, wherein the view record maintains a count of values from the base records and a current average of those values, and each view manager reads the count with the current average of values, the count being updated and provided to the storage device with the sequence number and the updated average.

28. A method for concurrent base record update propagation to view records, comprising:
receiving a plurality of updates for a plurality of base records; and
in each view manager of a plurality of view managers operable to maintain a view identifying an extreme value of the plurality of base records, performing operations comprising
receiving one of the updates;
attempting to read a current value of the view,
if the attempt fails, then attempting to insert the value from the received update,
and if the attempt succeeds, then receiving a sequence number associated with the received current value, and comparing the value from the received update with the read current value,
and if the comparison indicates that the value from the received update sets a new extreme compared with the read current value, then providing the value from the received update and the sequence number received by that view manager to the storage device;
receiving a response to the providing; and
if the response contains no error message, then treating the update as committed, and if the response includes an error message, then repeating the reading.

29. The method of claim 28, wherein the received update is for deleting the base record corresponding to the update, the extreme value maintained is equal to the received current value, and further comprising reading the values of the other base records to determine if another base record has a new extreme value, and if so then providing the new extreme value and the sequence number to the storage device.

30. The method of claim 28, wherein the extreme value is selected from a minimum value and a maximum value.
